(19) United States
(12) Patent Application Publication
(10) Pub. No.: US 2005/0096399 A1
(43) Pub. Date: May 5, 2005

(54) Method for recycling polyurethane and a composition comprising recycled polyurethane

(75) Inventors: Robert Donald Villwock, Grass Valley, CA (US); Bryan Louis Martel, Nevada City, CA (US); Shayne Drivdahl, Napa, CA (US)

Correspondence Address: Kristin C. Castle;Suite 100, 11231 Gold Express Drive, Sacramento, CA, 95670, US

(73) Assignee: Mobius Technologies, Inc.

(21) Appl. No.: 10/699,569

(22) Filed: Oct. 30, 2003

(51) Int. Cl. C08J 11/04

(52) U.S. Cl. 521/49

(57) ABSTRACT

The present invention comprises a method of recycling polyurethane-containing material. The method comprises combining a polyurethane-containing material with a solvent and forming a solution of the polyurethane-containing material and the solvent. Next, a non-solvent is added to the polyurethane solution to form a suspension of polyurethane in a solvent/non-solvent mixture. Finally, the solvent is removed to form a suspension of polyurethane in solvent. The solvent is preferably a polar, aprotic solvent. The solvent may be chosen from the group consisting of dimethylsulfoxide (DMSO), 1-methyl-2-pyrrolidone (NMP), N,N-dimethylformamide (DMF), acetonitrile, tetrahydrofuran (THF), hexamethylphosphoric acid triamide (HMPT) and mixtures thereof. The polyurethane-containing material may be chosen from the group consisting of foam trimmings, foam buns and foam skin, changeover blocks, off-specification material, polyurethane powder, molding mushrooms, fabrication scrap and post-consumer waste. In addition, the polyurethane-containing material may be prime polyurethane material. Finally a filtration step may be added to filter the solution before the non-solvent is added to form the suspension.

### BACKGROUND OF THE INVENTION

1. Field of the Invention

The present invention relates to a method of preparing suspensions of fine polyurethane particles in polyol. More specifically, the present invention relates to preparing suspensions of fine polyurethane particles in polyol by means of dissolution and precipitation. The present invention also provides a way of recycling polyurethane materials into new polyurethane articles by using the method of preparing suspensions of fine polyurethane particles in polyol.

2. Background

“Polyurethane” (PUR) describes a general class of polymers prepared by polyaddition polymerization of diisocyanate molecules and one or more active-hydrogen compounds. “Active-hydrogen compounds” include water and polyfunctional hydroxyl containing (or “polyhydroxyl”) compounds such as diols, polyester polyols, and polyether polyols. Active-hydrogen compounds also include polyfunctional amino-group-containing compounds such as polyamines and diamines. A common example of a polyether polyol is a glycerin-initiated polymer of ethylene oxide or propylene oxide.

“Polyurethane foams” are formed via a reaction between one or more active-hydrogen compounds and a polyfunctional isocyanate component, resulting in urethane linkages. Polyurethane foams are widely used in a variety of products and applications. These foams may be formed in wide range of densities and may be of flexible, semi-flexible, semi-rigid, or rigid foam structures. Generally speaking, “flexible foams” are those that recover their shape after deformation. In addition to being reversibly deformable, flexible foams tend to have limited resistance to applied load and tend to have mostly open cells. “Rigid foams” are those that generally retain the deformed shape without significant recovery after deformation. Rigid foams tend to have mostly closed cells. “Semi-rigid” or “semi-flexible” foams are those that can be deformed, but may recover their original shape slowly, perhaps incompletely. A foam structure is formed by use of“blowing agents.” Blowing agents are introduced during foam formation through the volatilization of low-boiling liquids or through the formation of gas due to chemical reaction. For example, a reaction between water and isocyanate forms carbon dioxide (CO₂) gas bubbles in polyurethane foam. This reaction also generates heat and results in urea linkages in the polymer. Additionally, surfactants may be used to stabilize the polymer foam structure during polymerization. Catalysts are used to initiate the polymerization reactions forming the urethane linkages and to control the blowing reaction for forming gas. The balance of these two reactions, which is controlled by the types and amounts of catalysts, is also a function of the reaction temperature.

Flexible polyurethane foams have a limited resistance to an applied load, they are open celled, permeable to air and reversibly deformable. Polyurethane foams can be chemically classified as polyester foam (foams comprising a polyester polyol) or polyether foams (foams comprising a polyether polyol). The type of polyol used affects the character of the foams. Thus, these foams differ in chemical and physical properties depending on the molecular structure of the polyol.

Polyester foams have good tensile strength and elongation. Polyester foam is superior to polyether foam with respect to elongation after compression molding. The polyester foam is also excellent with respect to oil resistance, solvent resistance and it is chemically stable. Further, polyester foam exhibits good heat-resistance. However, polyester foam exhibits great hysteresis loss and, thus is not suitable for use as a cushioning material.

Polyether foams, on the other hand, can be made with excellent flexibility and resilience. The use of polyether as a polyol instead of polyesters results in polyurethane foams with greatly improved elasticity. This change gave rise to the application of polyurethane foams to the upholstery market worldwide. Polyether foams can also be formulated to have no or very low resilience such as viscoelastic foams. Thus, the uses for polyurethane foams are widely diverse.

Typical processes for the manufacture of polyurethane or for the fabrication of useful articles from polyurethane also produce polyurethane scrap. For example, most polyurethane foam is produced as “slabstock” in a continuous pouring process. The resulting foam buns are often cut, for example, in pieces that are 1 to 2.5 m wide, 1.5 m high, and as long as 70 m. Foam buns are also made in boxes using batch processes. Foam buns generally require trimming of the top and sides before the buns are cut or sliced for commercial use. These top and side foam trimmings include a foam waste product containing production contaminants, which are discussed in greater detail below.

In either the “slabstock” process or the batch processes, the outside of the bun is lined with a paper or plastic release sheet, and a layer of dense polyurethane skin (or “foam skin”) is formed there. Foam skins are layers of non-foam or very high-density foam that are formed during the foam polymerization procedures. Foam skin is quite different in consistency and density from the desired foam product. The skin material is a tougher, more rubbery product, and has a higher density than the desired foam product. Foam skin is also present in scrap such as “mushrooms” of material that escapes the mold in foam molding operations. Foam skin is also found in off-spec molded parts.

In the “slabstock” process, there is a certain amount of waste generated during the change from a first grade of foam to a second grade of foam as the process is running. This waste is usually in the form of a foam block that has properties that do not meet the specifications of either grade of foam and is often called a “changeover block”. “Changeover blocks” is also often meant to include other off-spec material from the slabstock process such as start-up and shut-down material. These materials contain production contaminants.

As in the “slabstock” process and the batch processes discussed above, foam trimmings may also result from foam fabrication processes in which useful shapes are cut from larger foam blocks. This type of waste is called fabrication scrap, and it generally contains lower amounts of production contaminants than waste from trimming buns.

Polyurethane foam waste is also present in many discarded foam-containing products such as furniture, mattresses, automobile seats, carpet padding, thermal insulation foams, and packaging foams. This type of waste is called “post-consumer waste”. Post-consumer waste often contains contamination from other materials that were used in a fabricated part with the foam or from materials the foam was exposed to during its useful lifetime. These “consumer contaminants” include wood, ferrous metal, non-ferrous metal, textiles, leather, glass, dirt, oil, grease, adhesives, minerals, and plastics.

Foam manufacturers have tried ways to incorporate recycled polyurethane foam in the form of polyurethane powder into the manufacturing process of virgin polyurethane foam as a means for cost savings in production and for obvious environmental purposes.

Flexible polyurethane foam may be mechanically recycled by reducing foam scrap to particles having a maximum particle size of about 2 mm and introducing the particles in making new flexible polyurethane foam. In U.S. Pat. No. 4,451,583 to Chesler, polyurethane foam is comminuted to obtain particles. The comminuted particles are then added to the reaction mixture for the new polyurethane, or to one of the reactive liquid components such as the polyhydroxyl compounds, and then new flexible foam is prepared in a conventional manner. Cryogenic grinding is disclosed in the '583 patent as a preferred grinding technique for forming the required foam scrap particle size.

U.S. Pat. No.5,451,376 to Proska et al, discloses another mechanical recycling method using a polyurethane foam comminution process and apparatus. In the disclosed method, a fine comminution is carried out by forcing a mixture of coarsely comminuted material and one of the liquid polyurethane reaction components through one or more nozzles.

Some disadvantages of mechanical recycling methods like those shown and described in the Chesler and Proska patents are: they do not provide simple means for separation of contaminants, the large size of the particles relative to the foam structure affects foam properties, and the tendency of the particles to settle out of mixtures with the reactive liquid components. The tendency to settle requires that the particles be mixed with the reactive liquid components near the point of their use, and that the resulting slurry be mechanically agitated in some way to avoid settling. The Chesler method additionally requires expensive cryogenic fluids.

Methods for producing a stable suspension of fine particles of polyurethane in polyol and for producing foam with this suspension are needed. Further, in the handling of contaminated polyurethane scrap from industrial production or from post-consumer material, a need exists for an improved method for separation of contaminants from polyurethane material to facilitate re-use of the polyurethane material.

Hence what is needed are effective recycling technologies in order to re-use the foam waste, to remove contamination from foam waste, to maximize the raw material resources of these foams, to reduce or to eliminate the adverse environmental impact of polyurethane foam waste disposal, and to make polyurethane foam production more cost-effective. Particularly, a need exists for a processing method to take polyurethane foam, to disperse it as a suspension of fine particles in polyol that does not separate upon transport or long-term storage, and to use this suspension as a direct replacement for at least some of the polyol in the production of new polyurethane articles. This allows the points of use and manufacture of the suspension to be separated, removes a need for constant mechanical agitation of the mixture, and removes a need for complicated mixing and deaerating equipment at the point of use.

### SUMMARY OF THE INVENTION

The present invention comprises a method of recycling polyurethane-containing material. The method comprises combining a polyurethane-containing material with a solvent and forming a solution of the polyurethane-containing material and the solvent. Next, a non-solvent is added to the polyurethane solution to form a suspension of polyurethane in a solvent/non-solvent mixture. Finally, the solvent is removed to form a suspension of polyurethane in non-solvent. The solvent is preferably a polar, aprotic solvent. The solvent may be chosen from the group consisting of dimethylsulfoxide (DMSO), 1-methyl-2-pyrrolidone (NMP), N,N-dimethylformamide (DMF), acetonitrile, tetrahydrofuran (THF), hexamethylphosphoric acid triamide (HMPT) and mixtures thereof The polyurethane-containing material may be chosen from the group consisting of foam trimmings, foam buns and foam skin, changeover blocks, off-specification material, polyurethane powder, molding mushrooms, fabrication scrap and post-consumer waste. In addition, the polyurethane-containing material may be prime polyurethane material. Finally a filtration step may be added to filter the solution before the non-solvent is added to form the suspension. If the solvent has a lower boiling point than the non-solvent, then the solvent can be simply removed, for example by distillation, leaving a suspension of polyurethane in the non-solvent.

A better understanding of the features and advantages of the present invention will be obtained by reference to the following detailed description of the invention and accompanying drawings which set forth an illustrative embodiment in which the principles of the invention are utilized.

### BRIEF DESCRIPTION OF THE DRAWINGS

FIG. 1 is a flowchart illustrating one embodiment of the present method;

FIG. 2 is a flowchart illustrating another embodiment of the present method;

FIG. 3 is a flowchart illustrating yet another embodiment of the present method;

FIG. 4 is a flowchart illustrating yet another embodiment of the present method;

FIG. 5 is a flowchart illustrating yet another embodiment of the present method and

FIG. 6 is a flowchart illustrating yet another embodiment of the present method.

### DETAILED DESCRIPTION OF THE INVENTION

Those of ordinary skill in the art will realize that the following description of the present invention is illustrative only and not in any way limiting. Other embodiments of the invention will readily suggest themselves to such skilled persons.

Various aspects of the disclosure may be described through the use of flowcharts. Often, a single instance of an aspect of the present disclosure may be shown. As is appreciated by those of ordinary skill in the art, however, the protocols, processes, and procedures described herein may be repeated continuously or as often as necessary to satisfy the needs described herein. Accordingly, the representation of various aspects of the present disclosure through the use of flowcharts should not be used to limit the scope of the present disclosure.

In the context of the present invention, the following terms have the following meaning:

1. The expression “polyurethane-containing material” as used herein refers to polymers that contain the molecular structure of urethane —(—NH—CO—O—)— or of urea —(—NH—CO—NH—)— or both. Such polymers are typically obtained by reacting polyisocyanates with isocyanate-reactive hydrogen containing compounds, often using foaming agents, and in particular include cellular products obtained with water as reactive foaming agent (involving a reaction of water with isocyanate groups yielding urea linkages and carbon dioxide and producing polyurea-urethane foams) and with polyols, aminoalcohols, and/or polyamines as isocyanate-reactive compounds.

2. In the present disclosure, the word “average” refers to a mathematical average unless otherwise indicated.

3. In the present disclosure, the term “polyurethane powder” refers to polyurethane or polyurea-urethane materials in a powder form with a maximum particle size of 500 microns. One method for producing a polyurethane powder may be found in U.S. patent application Ser. No. 09/48,307, filed on Dec. 21, 2000 to Bryan Martel, Robert Villwock and Herman Stone and assigned to Mobius Technologies, Inc.

4. The word “solution” is defined in the present disclosure as a homogeneous mixture of two or more substances.

5. The term “homogeneous mixture” in the present disclosure is defined as a single-phase mixture of two or more compounds. That is, a mixture in which there are no apparent surfaces of discontinuity over supermolecular length scales.

6. In the present disclosure, the word “suspension” is defined as a heterogeneous mixture in which particles are dispersed throughout the bulk of a fluid. A “stable suspension” is defined as a suspension in which the particles do not significantly separate out from the fluid under the influence of gravity within a reasonable amount of time.

7. The term “heterogeneous mixture” in the present disclosure is defined as a mixture of two or more phases.

8. The word “solute” is defined in the present disclosure as the minor component in a solution, dissolved in the solvent.

9. The word “solvent” is defined in the present disclosure as the major component in a solution, in which a solute is dissolved.

10. As used in the present disclosure, the word “slurry” is defined as a primarily physical mixture of finely ground polyurethane powder mixed into polyol.

11. As used in the present disclosure, “production contaminant” is meant to include materials that are co-produced or used in the manufacture of foam and are typically present in the scrap trimmed from the sides, top, and bottom of slabstock or box foam. Examples of production contaminants include, but are not limited to, the foam skins discussed above. Additionally, the term includes the release sheets or separators also discussed above, that are, e.g., of paper, paper coated with wax or polyolefin, and also may be of film sheet, or netting made from polymer materials such as polyethylene, polypropylene, polystyrene, or other polyolefins. In the present disclosure, the release sheets containing some amount of any polymer are referred to as “polymeric sheets”.

12. “Polar aprotic solvent” means a solvent with a comparatively high relative permittivity (or dielectric constant), greater than about 15, and a sizable permanent dipole moment, that cannot donate suitably labile hydrogen atoms to form strong hydrogen bonds. Polar aprotic solvents are also variously referred to in chemistry literature as “dipolar aprotic solvent”, “dipolar non-protogenic solvent”, and “dipolar protophilic solvent”.

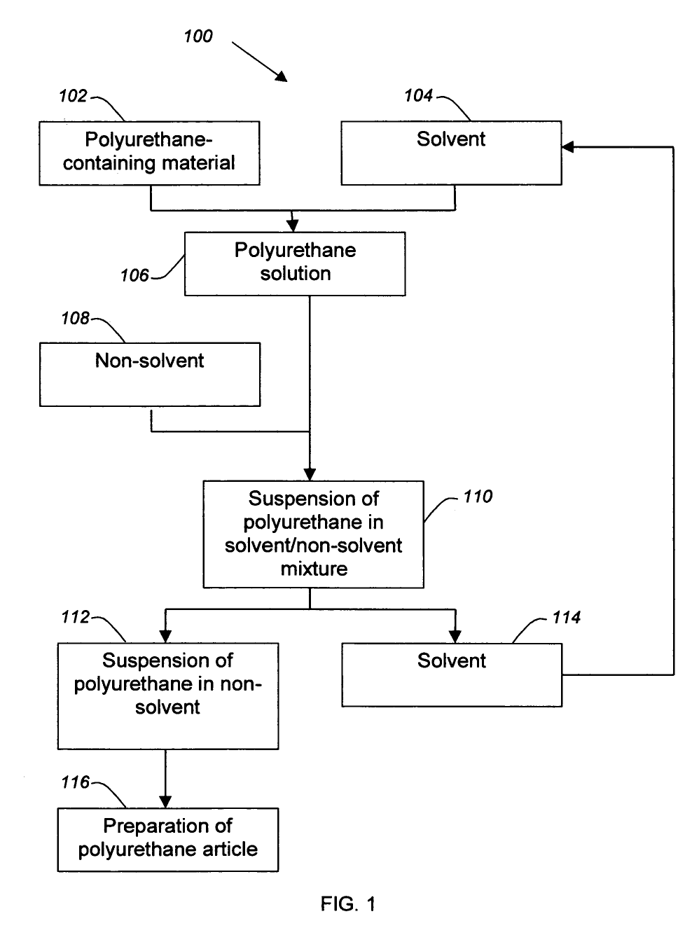

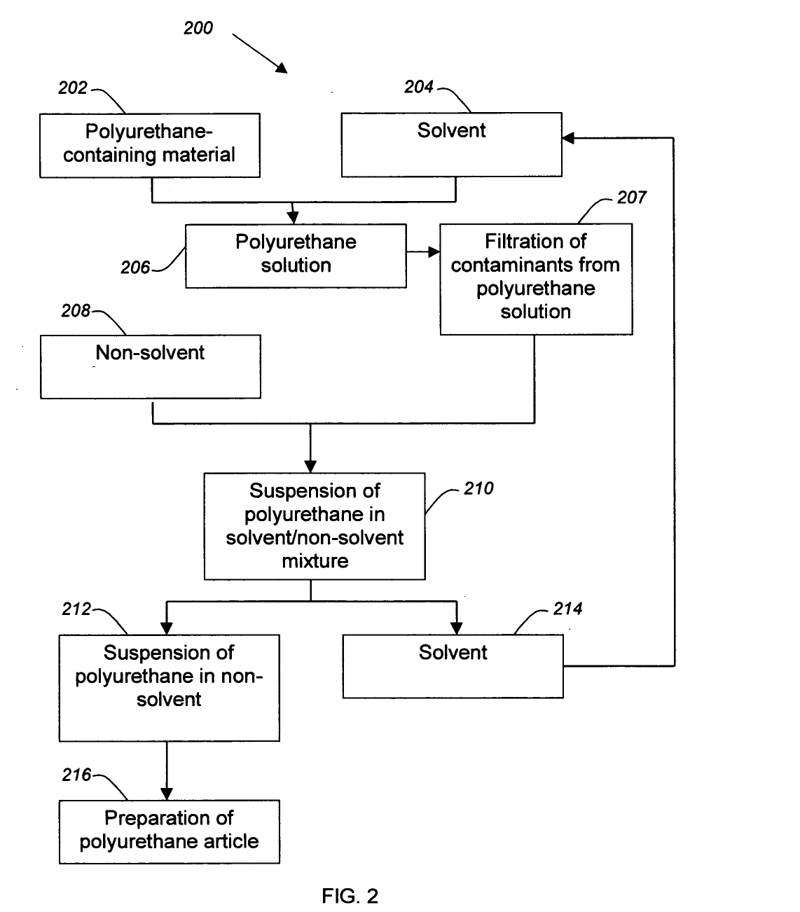

As discussed in detail in reference to Table 1 and FIGS. 1 and 2, it has been discovered that polyurethane-containing material can be dissolved in certain solvents, optionally filtered to remove any non-dissolving contaminants, precipitated as a fine suspension in a non-solvent (for example polyol), and stripped of solvent to form a stable suspension of fine polyurethane particles in polyol useful for the production of new polyurethane articles. Through this method any polyurethane-containing material can be recycled effectively. The polyurethane-containing starting material need not be free of contamination, and need not be finely ground. As discussed in greater detail below, the present invention requires only that the polyurethane-containing material dissolve in a solvent.

It has also been found that a polyurethane solution can be added to an existing polyol production process before the final stripping of volatiles from the polyol. This would make the precipitation of fine polyurethane occur in situ during the polyol manufacturing process, and would take maximum advantage of existing process equipment and supply infrastructure. The solvent can be subsequently recovered, for example by distillation, and reused for further dissolution of polyurethane.

FIG. 1 is a flowchart illustrating a method 100 of recycling polyurethane-containing material. Method 100 of recycling polyurethane-containing material begins by combining polyurethane-containing material 102 with solvent 104. Polyurethane-containing material includes, but is not limited to, production scrap including foam trimings, foam buns and foam skin, changeover blocks, off-specification material, polyurethane powder, molding mushrooms, fabrication scrap and post-consumer waste such as foam from auto-shredder residue. In addition, polyurethane-containing material 102 could be prime polyurethane material, and need not be limited to scrap or waste materials or foam to be an embodiment of the invention, though these forms of polyurethane have the advantage that they tend to be available inexpensively. Solvent 104 may be any solvent capable of dissolving polyurethane. Preferably solvent 104 may be a polar, aprotic solvent. Examples of polar aprotic solvents include, but are not limited to, dimethylsulfoxide (DMSO), 1-methyl-2-pyrrolidone (NMP), N,N-dimethylformamide (DMF), acetonitrile, tetrahydrofuran (THF), hexamethylphosphoric acid triamide (HMPT) and mixtures thereof, although not all of these are necessarily suitable for dissolving polyurethane. Most preferably, solvent 104 is dimethylsulfoxide. At step 106, polyurethane-containing material 102 and solvent 104 combine to form a polyurethane solution 106. The formation of the solution is preferably accelerated by application of heat. As would be obvious to one of ordinary skill in the art, there may be some degradation of the polymer in order to break a minimum number of cross links and form the solution.

Next, a non-solvent 108 including, but not limited to, polyol, water, acetone, or methylene chloride is combined with polyurethane solution 106 to form a suspension of polyurethane in a solvent/non-solvent mixture 110. The addition of a non-solvent preferably takes place under the influence of sufficient agitation in order to cause the precipitation of small particles. The rate of addition of a non-solvent may affect the particle-size distribution or the stability of the resulting suspension. Suspension of polyurethane in a solvent/non-solvent mixture 110 is then heated and stripped to remove solvent 114 leaving a fine suspension of polyurethane in non-solvent 112. Solvent 114 may be recycled back to step 104 for re-use in the present method. Finally, suspension of polyurethane in non-solvent may be used with the addition of polyisocyanate, water, and other chemicals known in the art to form polyurethane foam at step 116. An example of the method 100 is set forth below as Examples 1 and 2.

FIG. 2 is a flowchart illustrating another embodiment of the present method. FIG. 2 is a flowchart illustrating a method 200 of recycling polyurethane-containing material. Method 200 of recycling polyurethane begins by combining polyurethane-containing material 202 with solvent 204. Polyurethane-containing material and solvent have been described above in conjunction with FIG. 1 and will not be repeated herein to avoid overcomplicating the present disclosure. Next, at step 206 polyurethane-containing material 202 and solvent 204 combine to form a polyurethane solution 206. The formation of the solution is preferably accelerated by application of heat. At step 207, polyurethane solution 206 is filtered to remove any solid non-dissolving contaminants. Filtering step 207 may be accomplished by any means known to those of ordinary skill in the art to separate solids from liquids, such as settling, centrifugation, cyclone separation, sink-float separation, filtration (using for example filter presses, rotary-drum filters, rotary-disk filters, cartridge filters, vacuum assist, and filtration additives), and combinations of these means.

Next, a non-solvent 208 including, but not limited to, polyol, water, acetone, or methylene chloride is then combined with filtered polyurethane solution 207 to form a non-contaminated suspension of polyurethane in a solvent/non-solvent mixture 210. The addition of a non-solvent preferably takes place under the influence of sufficient agitation in order to cause the precipitation of small particles. The rate of addition of a non-solvent may affect the particle-size distribution or the stability of the resulting suspension. Suspension of polyurethane in a solvent/non-solvent mixture 210 is then heated and stripped to remove solvent 214 leaving a fine suspension of polyurethane in non-solvent is 212. Solvent 214 may be recycled back to step 204 for re-use in the present method. Finally, suspension of polyurethane in non-solvent may be used with the addition of polyisocyanate, water, and other chemicals known in the art to form polyurethane foam at step 216.

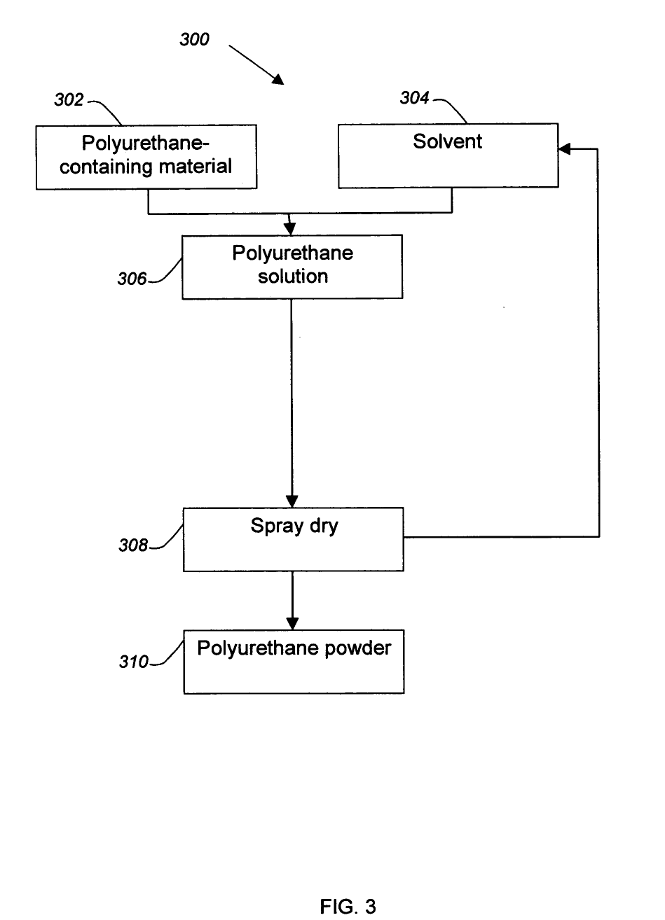

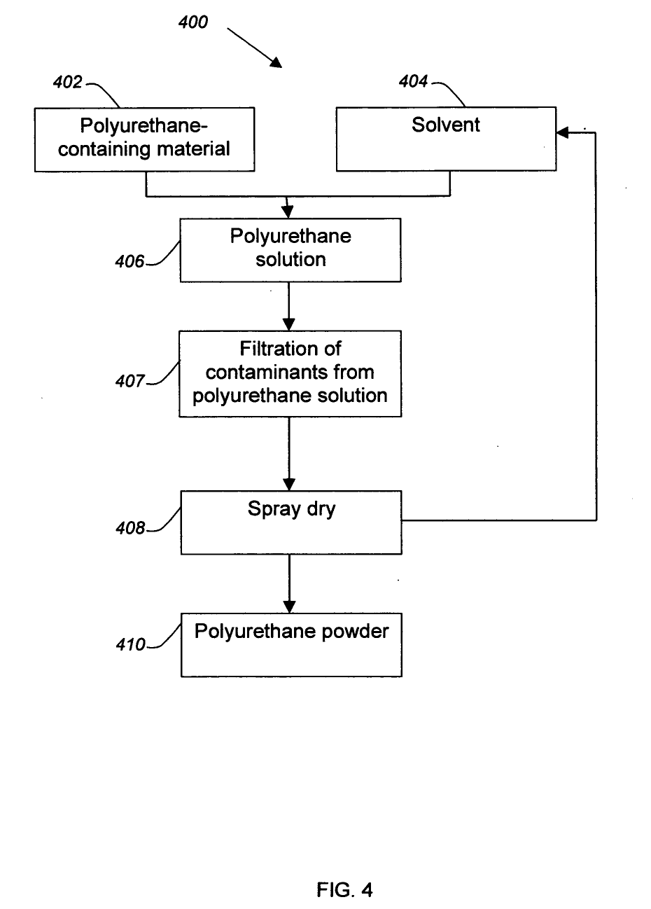

In yet another embodiment, illustrated further with respect to FIGS. 3 and 4, fine particles of polyurethane can be produced (without fine grinding) by spray-drying a polyurethane solution. These fine particles of polyurethane can be used like mechanically ground polyurethane in the production of new articles, but would have the advantage of controlled particle size and more uniform shape, which provide lower viscosity in slurries and better properties in foams.

FIG. 3 is a flowchart illustrating yet another embodiment of the present method. FIG. 3 is a flowchart illustrating a method 300 of recycling polyurethane. Method 300 of recycling polyurethane begins by combining polyurethane-containing material 302 with solvent 304. Polyurethane-containing material and solvent have been described above in conjunction with FIG. 1 and will not be repeated herein to avoid overcomplicating the present disclosure. Next, at step 306 polyurethane-containing material 302 and solvent 304 combine to form a polyurethane solution 306. The formation of the solution is preferably accelerated by application of heat. Next, at step 308 polyurethane solution is spray dried to form a fine polyurethane powder at step 310.

In a typical spray dryer, a solution, suspension or emulsion is pumped to an atomizer at the top of a drying chamber. The atomizer—a rotating wheel or a nozzle—sprays the liquid into a high-velocity stream of hot air or other gas, producing droplets. As the droplets pass through the hot air flow, the solvent rapidly evaporates. The large particles fall to the bottom of the chamber and are collected. Fine particles entrained with the exhaust are generally collected by passing air through a series of external cyclones, bags or filters. Atomizing is a critical component of the spray dryer in that it can produce droplets of a specific size and surface area. Certain atomizing techniques, well known to those of ordinary skill in the art of spray drying, can give good average particle size control which is very useful in the present invention for recycling polyurethane.

As stated above, these fine particles of polyurethane can be used like mechanically ground polyurethane in the production of new articles. Spray-dried particles have the additional advantage over mechanically ground particles of controlled particle size and more uniform shape, which provides a lower viscosity in slurries and better properties in foams.

Solvent 304 may be recovered from the spray-drying step 308 and reused in the process.

FIG. 4 is a flowchart illustrating yet another embodiment of the present method. FIG. 4 is a flowchart illustrating a method 400 of recycling polyurethane. Method 400 of recycling polyurethane begins by combining polyurethane-containing material 402 with solvent 404. Polyurethane-containing material and solvent have been described above in conjunction with FIG. 1 and will not be repeated herein to avoid overcomplicating the present disclosure. Next, at step 406 polyurethane-containing material 402 and solvent 404 combine to form a polyurethane solution 406. The formation of the solution is preferably accelerated by application of heat. At step 407, polyurethane solution 406 is filtered to remove any solid, non-dissolving contaminants. Next, at step 408 polyurethane solution is spray dried to form a fine polyurethane powder at step 410. Again, these fine particles of polyurethane can be used like mechanically ground polyurethane in the production of new articles, but would have the additional advantages of controlled particle size, more uniform shape, and being free from any contaminants, which provides a lower viscosity in slurries and better properties in foams.

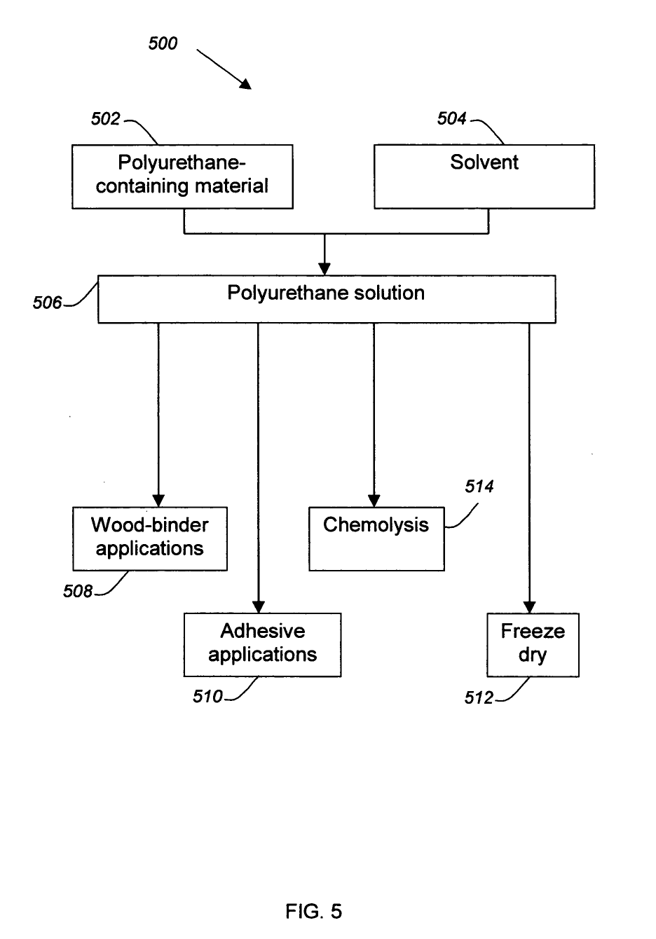

FIG. 5 is a flowchart illustrating yet another embodiment of the present method. FIG. 5 is a flowchart illustrating a method 500 of recycling polyurethane. Method 500 of recycling polyurethane begins by combining polyurethane-containing material 502 with solvent 504. Polyurethane-containing material and solvent have been described above in conjunction with FIG. 1 and will not be repeated herein to avoid overcomplicating the present disclosure. Next, at step 506 polyurethane-containing material 502 and solvent 504 combine to form a polyurethane solution 506. The formation of the solution is preferably accelerated by application of heat. At step 510, polyurethane solution 506 may be used directly in adhesive applications. Solution 506 is applied to a substrate, the substrate is bonded to another substrate by contacting the substrate surfaces with the solution 506 between them, and the solvent is allowed to evaporate, leaving a polyurethane layer binding the two substrates together.

Polyurethane chemistry is a valuable tool in the adhesive bonding industry. Polyurethane adhesives are normally defined as those adhesives that contain a number of urethane groups in the molecular backbone or are formed during use, regardless of the chemical composition of the rest of the chain. Thus, a typical urethane adhesive may contain, in addition to the urethane linkages, aliphatic and aromatic hydrocarbons, esters, ethers, amides, urea, biuret, and allophanate groups.

An isocyanate group reacts with the hydroxyl groups of a polyol to form the repeating urethane linkage. Isocyanates will react with water to form a urea linkage and carbon dioxide as a by-product. Polyurethanes may be linear or cross-linked. Cross-liked polyurethane adhesives will not flow when heated while linear polyurethane adhesives will.

Urethane adhesives make good adhesives because they effectively wet the surfaces of most substrates, they can interact with the substance through polar interactions, and their relatively low molecular weight allows them to permeate porous substrates. In addition, urethane adhesives make good adhesives because they can form covalent bonds with substrates that have active hydrogen atoms (reactive adhesives) and through molecular composition the adhesive stiffness, elasticity and cross-linking can be tailored to meet to meet specific needs.

Reactive polyurethane adhesives such as aromatic isocyanates (predominantly MDI) are used as binders to manufacture oriented strand board, medium density fiberboard and particleboard. For this use, the isocyanate is blended with wood strands, fibers and chips, respectively. The curing in binding applications takes place at approximately 200° C. The curing reaction is predominantly via the reaction with water and thus the formation of urea groups.

Referring again to FIG. 5, next, at step 508, polyurethane solution 506 may be used directly as a binder for fibrous materials in applications such as the formation of particleboard or other sheets or board products. Fibrous materials useful in these applications include cellulose fiber, recycled carpet fiber, glass fiber and scrap materials from industrial parts that may contain various mineral, synthetic or organic fibers. Examples of these latter scrap materials include scrap from thermoforming operations with glass fibers and scrap from headliner, door panel, or interior panel manufacture in the automobile industry. Examples of cellulose-fiber materials include sawdust, wood chips, paper fiber and other fiber from natural sources such as wood, straw, rice, hemp, jute, flax and cotton. In its use as a binder at step 50888, polyurethane solution 506 may be applied to the surfaces of fibrous materials to form a mixture. The mixture may then be combined under heat and/or pressure with the removal of solvent to produce a polyurethane-cellulose composite material with reduced use of isocyanate binders.

Alternatively, at step 512, polyurethane solution 506 can be separated into solvent 504 and polyurethane powder (useful as a replacement for mechanically ground polyurethane) by a variety of means such as evaporation of the solvent, freeze drying, precipitation and any other means known in the art to separate a solvent from a solute. In addition, at step 514, polyurethane solution 506 may be subjected to chemolysis. As is well known to those of ordinary skill in the art, chemolysis is depolymerization applicable to the recycling of polyurethanes—it is the use of a chemical to break down the back bone of the polymer. In this type of process, the molecules are broken down into smaller building blocks, which then may be reassembled into polymers suitable for use in quality applications to those for which the original components were employed. Water (hydrolysis), glycols (glycolysis), organic acids (acidolysis) and amines (aminolysis) typically serve as reagents to break the urethane and urea bonds., generally to produce one or more polyols form the polyurethane. The initial formation of polyurethane solution 506 can improve thee chemolysis process by accelerating the reactions, lowering the operating temperature, and reducing the rate of side reactions

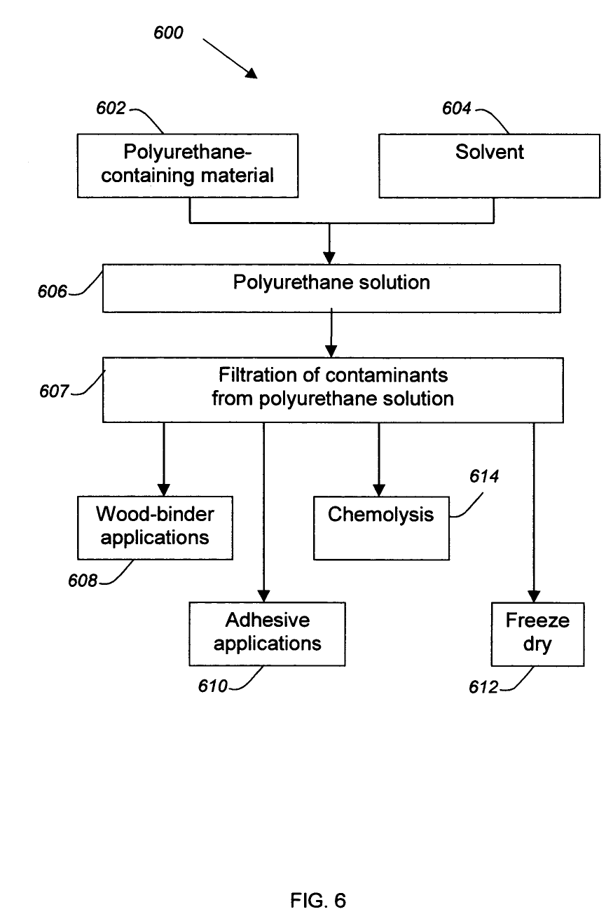

FIG. 6 is a flowchart illustrating yet another embodiment of the present method. FIG. 6 is a flowchart illustrating a method 600 of recycling polyurethane. Method 600 of recycling polyurethane begins by combining polyurethane-containing material 602 with solvent 604. Polyurethane-containing material and solvent have been described above in conjunction with FIG. 1 and will not be repeated herein to avoid overcomplicating the present disclosure. Next, at step 606 polyurethane-containing material 602 and solvent 604 combine to form a polyurethane solution 606. The formation of the solution is preferably accelerated by application of heat. At step 607, polyurethane solution 606 is filtered to remove any contaminants. Referring again to FIG. 6, next, at step 608, polyurethane solution 606 may be used directly in general binder applications such as the formation of particleboard, carpet fiber, glass fiber, and scrap materials form industrial parts that may contain various mineral, synthetic or organic fibers. At step 610, polyurethane solution 606 may be used directly in adhesive applications.

Alternatively, at step 612, polyurethane solution 606 can be separated into solvent 604 and polyurethane powder (useful as a replacement for mechanically ground polyurethane) by a variety of means such as evaporation of the solvent, freeze drying, precipitation and any other means known in the art to separate a solvent from a solute. In addition, as described above, at step 614, polyurethane solution 606 may be subjected to chemolysis.

Table 1 illustrates the results of an example in which polyol, polyurethane-containing material, a suspension of polyurethane-containing material in polyol and a slurry of polyurethane-containing material in polyol were analyzed by a Fourier-transform infrared (FTIR) spectrometer. Infrared spectroscopy is an important technique in organic chemistry in that it is an easy way to identify the presence of certain functional groups in a molecule. In addition, the unique collection of absorption bands can be used to confirm the identity of a pure compound or to detect the presence of specific impurities. The positions of the prominent peaks in the FTIR spectra are shown in Table 1.

In the example set forth in Table 1 the “polyol” is a potassium bromide (KBr) sandwich of Dow VORANOL® 3010 polyether polyol. Polyol is the raw material that comprises about 70% by weight of most flexible polyurethane foam. This polyol is a liquid oligomer made from glycerin reacted with ethylene oxide and propylene oxide to produce a triol with a molecular weight of approximately 3500 and a viscosity of approximately 500 cP. The “polyurethane-containing material (PUR)” is a KBr pellet of finely ground polyurethane powder obtained from mechanical grinding of various conventional flexible polyether polyurethane foams. The “suspension” is a KBr sandwich of the resulting material after distilling off the solvent as discussed above as suspension 112 in FIG. 1. The concentration of the suspension is approximately 16.7% by weight of polyurethane-containing material in polyol. The suspension was produced from the same polyurethane-containing material and polyol shown in Table 1. Finally, the “slurry” is a purely physical mixture of finely ground polyurethane-containing material mixed into polyol at approximately the same concentration as the “suspension” sample. The slurry was produced from the same polyurethane-containing material and polyol shown in Table 1.

TABLE 1

| Polyol | PUR | Suspension | Slurry |
|---|---|---|---|
| 2971 | 2972 | 2971 | 2970 |
| 2931 | 2930 | 2930 | 2930(sat.) |
| 2895 | 2895 | 2895 | 2895(sat.) |
| 2870 | 2870 | 2870 | 2870 |
| 1730 | 1730 | 1730 | 1730 |
| — | 1640 | 1639 | 1643 |
| — | 1601 | 1601 | 1600 |
| — | 1540 | 1541 | 1540 |
| 1456 | 1455 | 1455 | 1455 |
| 1374 | 1374 | 1374 | 1374 |
| 1345 | 1344 | 1344 | 1344 |
| 1298 | 1297 | 1297 | 1297 |
| 1259 | — | 1259 | 1258 |
| — | 1230 | 1230 | 1230 |
| 1111 | 1110 | 1110 | 1110(sat.) |
| 1014 | 1014 | 1014 | 1014 |
| 928 | 928 | 928 | 928 |
| 867 | 866 | 866 | 866 |

Table 1 illustrates that the peak positions (in wavenumbers, with units of cm⁻¹) for each prominent peak in the FTIR spectra of “polyol”, “polyurethane-containing material”, “suspension” of polyurethane-containing material in polyol as set forth above with reference to FIGS 1 and 2 and “slurry” of polyurethane-containing material in polyol are almost identical. The results as shown in Table 1 indicate that the “suspension” sample is chemically nearly identical to the “slurry” sample. These results are a further indication that there is little or no degradation of the “suspension” sample. Thus, when the polyurethane-containing material is dissolved in the solvent and then precipitated out by the polyol, there is little or no chemical degradation of the polyurethane-containing material.

The above discussion is exemplified in the examples set forth below. The examples set forth below are for illustrative purposes only and are in no way meant to limit the present invention.

### EXAMPLE 1

Flexible-slabstock polyurethane foam production scrap was obtained from trimming the skins from foam buns. The scrap contained small amounts of dense skin material and polyethylene film, with the balance being polyurethane foam of varying density. This scrap material was first reduced to pieces with a size of approximately 1 cm. The foam pieces were then comminuted using a two-roll mill, resulting in a fine powder. A 55-gram portion of the powder was dissolved in about 500 mL of dimethylsulfoxide (DMSO, C₂H₃SO) under a nitrogen atmosphere at about 130° C. for about 120 minutes to produce a 605 grams of a homogeneous, transparent, single liquid phase with a concentration of about 9.1% polyurethane by weight in DMSO. The solution was cooled to about 40° C. Then, about 300 grams of VORANOL 3010 polyether polyol obtained from The Dow Chemical Company was added to the solution. The resulting mixture was heated to about 110° C. and distilled under vacuum for several hours to separate the DMSO. After removal of practically all of the DMSO, cooling, and then removing vacuum, a fine suspension of polyurethane in polyol was obtained. This suspension did not separate into layers or settle over the next 10 weeks.

### EXAMPLE 2

A polyurethane foam was prepared using 118 parts of the polyurethane/polyol suspension described in Example 1, 58 parts of VORANATE T-80 toluene diisocyanate from Dow, 1 part of L-603 silicone surfactant from Witco, 0.12 parts of NIAX A-1 amine catalyst from Witco, 0.04 parts of DABCO 33-LV amine catalyst from Air Products, and 0.20 parts of DABCO T-9 tin catalyst from Air Products. These ingredients were mixed together using a Silverson lab mixer, then quickly poured into an 8-inch square box where the mixture foamed, rose to fill the box, then cured to a solid within about 2 minutes. The foam was then further cured in an oven at 120° C. for 1 hour. After cooling, a sample of the foam was cut from the middle and tested according to ASTM 3574-95, by which it was determined that the foam had a density of 27 kg/m³, a ball-rebound resilience of 40%, and a 40% CFD value of 2.28 kPa The cell structure of the foam and the overall quality were acceptable for typical polyurethane-foam applications such as furniture.

A composition comprising recycling polyurethane-containing material comprises another aspect of the present invention. The composition of the present invention is formed by dissolving recycled polyurethane-containing material in a solvent. The polyurethane-containing material includes, but is not limited to, production scrap including foam trimmings, foam buns and foam skin, changeover blocks, off-specification material, polyurethane powder, molding mushrooms, fabrication scrap and post-consumer waste such as foam from auto-shredder residue. In addition, the polyurethane-containing material could be prime polyurethane material, and need not be limited to scrap or waste materials or foam to be an embodiment of the invention, though these forms of polyurethane have the advantage that they tend to be available inexpensively. The solvent may be any solvent capable of dissolving polyurethane. Preferably solvent may be a polar, aprotic solvent. Examples of polar aprotic solvents include, but are not limited to, dimethylsulfoxide (DMSO), 1-methyl-2-pyrrolidone (NMP), N,N-dimethylformamide (DMF), acetonitrile, tetrahydrofuran (THF), hexamethylphosphoric acid triamide (HMPT) and mixtures thereof, although not all of these are necessarily suitable for dissolving polyurethane. Most preferably, solvent is dimethylsulfoxide. The polyurethane-containing material and solvent combine to form a polyurethane solution. The formation of the solution is preferably accelerated by application of heat. As would be obvious to one of ordinary skill in the art, there may be some degradation of the polymer in order to break a minimum number of cross [inks and form the solution.

A non-solvent, including, but not limited to, polyol, water, acetone, or methylene chloride is combined with the polyurethane solution to form a suspension of polyurethane in a solvent/non-solvent mixture. The addition of a non-solvent preferably takes place under the influence of sufficient agitation in order to cause the precipitation of small particles. The rate of addition of a non-solvent may affect the particle-size distribution or the stability of the resulting suspension. The suspension of polyurethane in a solvent/non-solvent mixture is then heated and stripped to remove solvent leaving a composition of polyurethane in non-solvent. Finally, the composition of polyurethane in non-solvent may be used with the addition of polyisocyanate, water, and other chemicals known in the art to form polyurethane foam.

The above examples are for illustrative purposes only and are in no way meant to limit the present invention. As would be obvious to one of ordinary skill in the art, the examples of solvents, non-solvents and recycled polyurethane products are set forth for illustrative purposes only and do not contain an exclusive or exhaustive list of available solvents, non-solvents and polyurethane products, recycled or otherwise.

It should be understood that various alternatives to the embodiments of the disclosed method and apparatus descried herein maybe employed in practicing the disclosed method and using the disclosed apparatus. It is intended that the following claims define the scope of the disclosed method and apparatus and that methods and structures within the scope of these claims and their equivalents be covered thereby.

1. A method of recycling polyurethane-containing material comprising:
combining a polyurethane-containing material with dimethylsulfoxide (DMSO);
forming a solution of said polyurethane-containing material and said dimethylsulfoxide (DMSO);
adding a non-solvent to said polyurethane solution to form a suspension of polyurethane in a dimethylsulfoxide (DMSO)/non-solvent mixture; and
removing said dimethylsulfoxide (DMSO) to form a suspension of polyurethane in said non-solvent.

2. The method of claim 1 wherein said polyurethane-containing material is chosen from the group consisting of foam trimmings, foam buns and foam skin, changeover blocks, off-specification material, polyurethane powder, molding mushrooms, fabrication scrap and post-consumer waste.

3. The method of claim 1 wherein said polyurethane-containing material is prime polyurethane material.

4. The method of claim 1 further comprising applying heat to said polyurethane-containing material and said solvent during said combining step.

5. The method of claim 1 further comprising adding a filtration step after said forming a solution step and filtering said solution.

6. A method of recycling polyurethane-containing material comprising:
combining a polyurethane-containing material with dimethylsulfoxide (DMSO);
forming a solution of said polyurethane-containing material and said dimethylsulfoxide (DMSO), and
spray drying said solution to produce fine particles of said polyurethane-containing material.

7. The method of claim 6 wherein said polyurethane-containing material is chosen from the group consisting of foam trimmings, foam buns and foam skin, changeover blocks, off-specification material, polyurethane powder, molding mushrooms, fabrication scrap and post-consumer waste.

8. The method of claim 6 wherein said polyurethane-containing material is prime polyurethane material.

9. The method of claim 6 further comprising applying heat to said polyurethane-containing material and said solvent during said combining step.

10. The method of claim 6 further comprising adding a filtration step after said forming a solution step and filtering said solution.

11. The method of claim 6 further comprising recycling said solvent after said spray drying step.

10. A method of forming an adhesive using polyurethane-containing material comprising:
combining a polyurethane-containing material with a solvent;
forming a solution of said polyurethane-containing material and said solvent; and
binding a plurality of materials with said solution of said polyurethane-containing material and said solvent wherein said solvent is allowed to evaporate.

11. The method of claim 10 wherein said solvent is a polar, aprotic solvent.

12. The method of claim 10 wherein said solvent is chosen from the group consisting of dimethylsulfoxide (DMSO), 1-methyl-2-pyrrolidone (NMP), N,N-dimethylformamide (DMF), acetonitrile, tetrahydrofuran (THF), hexamethylphosphoric acid triamide (HMPT) and mixtures thereof.

13. The method of claim 10 wherein said polyurethane-containing material is chosen from the group consisting of foam trimmings, foam buns and foam skin, changeover blocks, off-specification material, polyurethane powder, molding mushrooms, fabrication scrap and post-consumer waste.

14. The method of claim 10 wherein said polyurethane-containing material is prime polyurethane material.

15. The method of claim 10 further comprising applying heat to said polyurethane-containing material and said solvent during said combining step.

16. The method of claim 10 further comprising adding a filtration step after said forming a solution step and filtering said solution.

17. A method of binding using polyurethane-containing material comprising:
combining a polyurethane-containing material with dimethylsulfoxide (DMSO);
forming a solution of said polyurethane-containing material and said dimethylsulfoxide (DMSO); and
binding a fibrous materials including at least one of a cellulose fiber, recycled carpet fiber, glass fiber and scrap materials from industrial parts that may contain various mineral, synthetic or organic fibers, wherein said fiberous materials with said solution of said polyurethane-containing material is heated and pressurized to remove said solvent and produce a polyurethane-fiber composite material.

18. The method of claim 17 wherein said polyurethane-containing material is chosen from the group consisting of foam trimmings, foam buns and foam skin, changeover blocks, off-specification material, polyurethane powder, molding mushrooms, fabrication scrap and post-consumer waste.

19. The method of claim 17 wherein said polyurethane-containing material is prime polyurethane material.

20. The method of claim 17 further comprising applying heat to said polyurethane-containing material and said solvent during said combining step.

21. The method of claim 17 further comprising adding a filtration step after said forming a solution step and filtering said solution.

22. A method of recycling polyurethane-containing material comprising:
combining a polyurethane-containing material with dimethylsulfoxide (DMSO);
forming a solution of said polyurethane-containing material and said dimethylsulfoxide (DMSO); and
separating polyurethane-containing material from said solution and producing polyurethane powder.

23. The method of claim 22 wherein said polyurethane-containing material is chosen from the group consisting of foam trimmings, foam buns and foam skin, changeover blocks, off-specification material, polyurethane powder, molding mushrooms, fabrication scrap and post-consumer waste.

24. The method of claim 22 wherein said polyurethane-containing material is prime polyurethane material.

25. The method of claim 22 further comprising applying heat to said polyurethane-containing material and said solvent during said combining step.

26. The method of claim 22 further comprising adding a filtration step after said forming a solution step and filtering said solution.

27. The method of claim 22 wherein said separation step comprises evaporation of said solvent.

28. The method of claim 22 wherein said separation step comprises freeze drying said solution.

28. The method of claim 22 wherein said separation step comprises precipitating said polyurethane powder from said solution.
